(19) United States
(12) Patent Application Publication
(10) Pub. No.: US 2014/0331399 A1
(43) Pub. Date: Nov. 13, 2014

(54) Pool Lift Portability Method and Apparatus

(71) Applicant: Global Lift Corporation, Bad Axe, MI (US)

(72) Inventors: Joshua Steinman, Pigeon, MI (US); Lee Steinman, Pigeon, MI (US); Dale Steinman, Pigeon, MI (US)

(21) Appl. No.: 14/358,341

(22) PCT Filed: Nov. 15, 2012
(86) PCT No.: PCT/US2012/065346

§ 371 Date: May 15, 2014

Related U.S. Application Data
(60) Provisional application No. 61/559,756, filed on Nov. 15, 2011.

(51) Int. Cl. A61G 7/10; B66F 5/00

(52) U.S. Cl. CPC A61G 7/1073; A61G 7/1005; B66F 5/00; A61G 2200/34
USPC 4/496; 254/2 R

(57) ABSTRACT

An apparatus is provided for rendering a pool lift portable. The apparatus comprises a forewheel assembly comprising a forewheel attached to a base of a pool lift adjacent a forward edge of the base, and a jack comprising a jack wheels. The jack may be attached to the pool lift base in a position where the jack wheel is spaced from the forewheel, and the jack may be actuated to alternately lift and lower the apparatus by alternately moving the jack wheel between extended and retracted positions so as to rotate the pool lift base about the forewheel such that the pool lift base is in contact with a supporting surface when the jack wheel is in its retracted position, and such that the pool lift base is supported in a transport position spaced from the supporting surface by the forewheel and the jack wheel when the jack wheel is in its extended position. The apparatus may include a seat attitude maintenance linkage comprising a single-side two-link crank linkage having a long link spaced to prevent pinching.

### FIELD OF THE INVENTION

This invention relates generally to providing pool lift portability.

### BACKGROUND

The Americans with Disabilities Act (ADA) sets forth standards and requirements regarding the accessibility of swimming pools to handicapped or disabled persons. Public pools are required to have at least one method of disabled access, commonly manifested in the form of a ramp or lift, and the act describes extensive systems, design, and operation specifications required for a lift device to be considered ADA compliant. Common lift engineering challenges include securing the lift to the ground, transporting the lift between storage and use locations, providing a strong and steady drive system to operate the lift, stabilizing the lift's chair to remain upright during deployment, and incorporating safety systems.

### SUMMARY

A pool lift portability apparatus is provided comprising a first forewheel assembly configured to be attached to a pool lift base adjacent a forward edge of the pool lift base and comprising a first forewheel supported for rotation about a first forewheel axis. The apparatus also includes a jack comprising a first jack wheel supported for rotation about a first jack wheel axis. The jack is configured for attachment to the lift base in a position where the first jack wheel is spaced from the first forewheel. The jack is actuable to alternately lift and lower the pool lift by alternately moving the first jack wheel between extended and retracted positions so as to rotate the pool lift base about the first forewheel axis so that the pool lift base is in contact with a supporting surface when the first jack wheel is in its retracted position, and so that the pool lift base is supported by the first forewheel and the first jack wheel in a transport position spaced from the supporting surface when the first jack wheel is in its extended position.

A pool lift apparatus is provided comprising a base supportable on a surface adjacent an edge of a basin and generally above a surface level of fluid retained in the basin. A main beam is supported on the base at a main beam inner end for pivotal motion about a base axis. A seat is supported on the main beam adjacent an outer end of the main beam for pivotal motion about a seat axis oriented generally parallel to the base axis, the seat being configured to carry a passenger. A driver is connected between the main beam and a fixed structure adjacent the basin and actuable to pivot the main beam about the base axis between a deployed position suspending the seat at least partially within the basin, and a stowed position suspending the seat in a position displaced laterally from the basin. The apparatus also includes a seat attitude maintenance linkage comprising a single-side two-link crank linkage. The linkage includes a short link supported for pivotal motion about the seat axis and connected to the seat, and a long link that is pivotally connected adjacent a long link outer end to a short link upper end at an outer pivot point shared with the short link, and that is pivotally connected adjacent a long link inner end to the base at an inner pivot point. The outer pivot point is spaced from the chair pivot point in a direction generally parallel to a direction the inner pivot point is spaced from the base axis, and the long link being spaced from the main beam by a distance sufficient to eliminate shearing action between the long link and the main beam as the driver and linkage move the main beam between its deployed and stowed positions.

### DESCRIPTION OF DRAWINGS

These and other features and advantages will become apparent to those skilled in the art in connection with the following detailed description and the drawings disclosing one or more embodiments of the invention, in which:

FIG. 1 is a perspective view of a pool lift portability apparatus mounted to a pool lift apparatus;

FIG. 2 is a magnified fragmentary view of the pool lift portability apparatus of FIG. 1 mounted to a base of the pool lift apparatus of FIG. 1;

FIG. 3 is second magnified fragmentary view of the pool lift portability apparatus of FIG. 1 mounted to a base of the pool lift apparatus of FIG. 1;

FIG. 4 is a partial cross-sectional side view of the pool lift portability apparatus of FIG. 1 mounted to a base of the pool lift apparatus of FIG. 1 with a jack wheels of the pool lift portability apparatus in respective extended potions, raising the pool lift apparatus from a supporting surface onto jack wheels and forewheels of the pool lift apparatus;

FIG. 5 is a partial cross-sectional side view of the pool lift portability apparatus of FIG. 1 mounted to a base of the pool lift apparatus of FIG. 1 with a jack wheels of the pool lift portability apparatus in respective retracted potions positioning the base of the pool lift apparatus on the supporting surface;

FIG. 6 is a rear view of the pool lift apparatus showing a seat attitude maintenance linkage of the pool lift apparatus;

FIG. 7 is a side view of the pool lift apparatus with a main beam of the apparatus supporting a seat of the apparatus in a deployed position with the seat at least partially submerged in a swimming pool;

FIG. 8 is a side view of the pool lift apparatus in a stowed position;

FIG. 9 is a magnified view of a portion of the pool lift enclosed in region 9 of FIG. 8; and

FIG. 10 is a magnified view of a portion of the pool lift enclosed in region 10 of FIG. 8.

### DETAILED DESCRIPTION OF INVENTION EMBODIMENT(S)

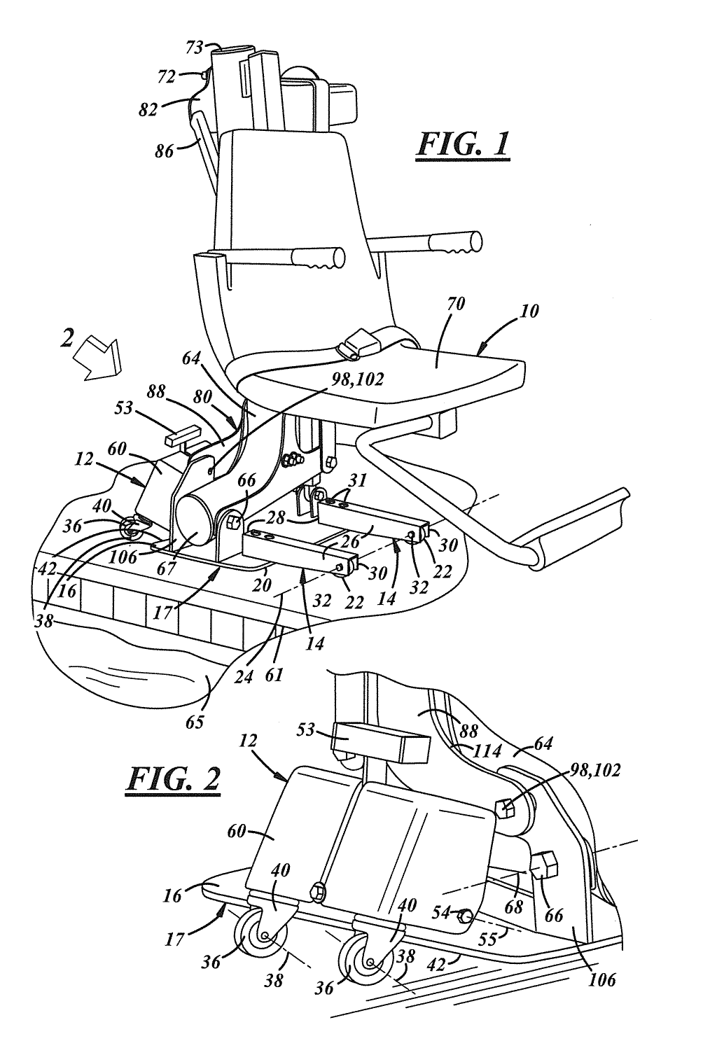

A pool lift apparatus and a pool lift portability apparatus are generally indicated at 10 and 12, respectively, in FIGS. 1-10. The portability apparatus 12 may include two forewheel assemblies 14 that may be removably attached to a base plate 16 of a base 17 of the pool lift apparatus 10. Each forewheel assembly 14 may be attached adjacent a forward edge 20 of the base plate 16, and may comprise a forewheel 22 supported for rotation about a forewheel axis 24.

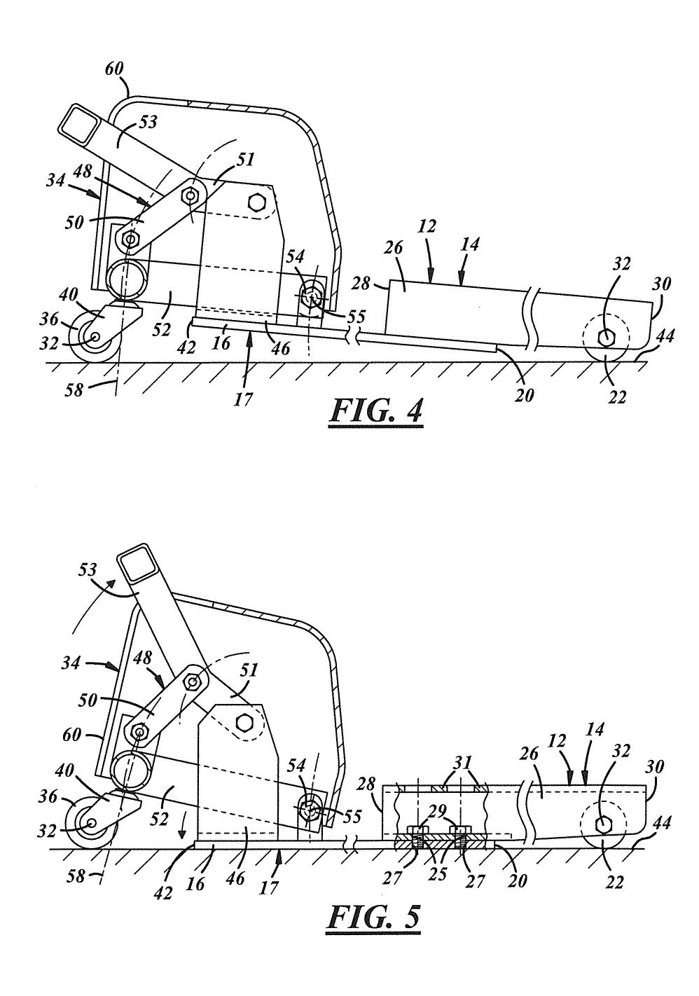

As best shown in FIGS. 4 and 5 The forewheel assemblies 14 may include forearms 26 having forearm aft ends 28 which may be removably and rigidly attached to the pool lift base plate 16 adjacent the forward edge 20 of the portability apparatus base plate 16. Forearm attachment may be accomplished by first positioning forearm fastener holes 25 in coaxial alignment with threaded base plate fastener holes 27, then passing threaded fasteners 29 through relatively larger diameter upper access holes 31, and through the forearm fastener holes 25 and into threaded engagement with the base plate fastener holes 27 as shown in FIG. 5.

The forearms may extend forward from their aft ends 28 beyond the forward edge 20 of the portability apparatus base plate 16 to respective forearm forward ends 30. The forewheels 22 may be supported on generally horizontal metal axles 32 carried by the forearms 26 for rotation about the forewheel axis 24 adjacent the forearm forward ends 30 to ease the lifting of the pool lift apparatus 10 by providing a longer torque arm distance between the forewheels 22 and an aft-mounted jack 34. The forewheels 22 may be fixed in a coaxial relationship to one another in the present embodiment, but in other embodiments may be castered, i.e., supported for pivotal motion about generally vertical axes.

As best shown in FIGS. 2, 3, and 6, the jack 34 may comprise two jack wheels 36 supported for rotation about respective jack wheel axes 38 upon respective metal axles 32 carried by respective metal jack wheel forks 40. The jack 34 may be releasably attached to the portability apparatus base plate 16 adjacent an aft edge 42 of the portability apparatus base plate 16 in a position disposing the jack wheels 36 in respective positions spaced aft of the forewheels 22.

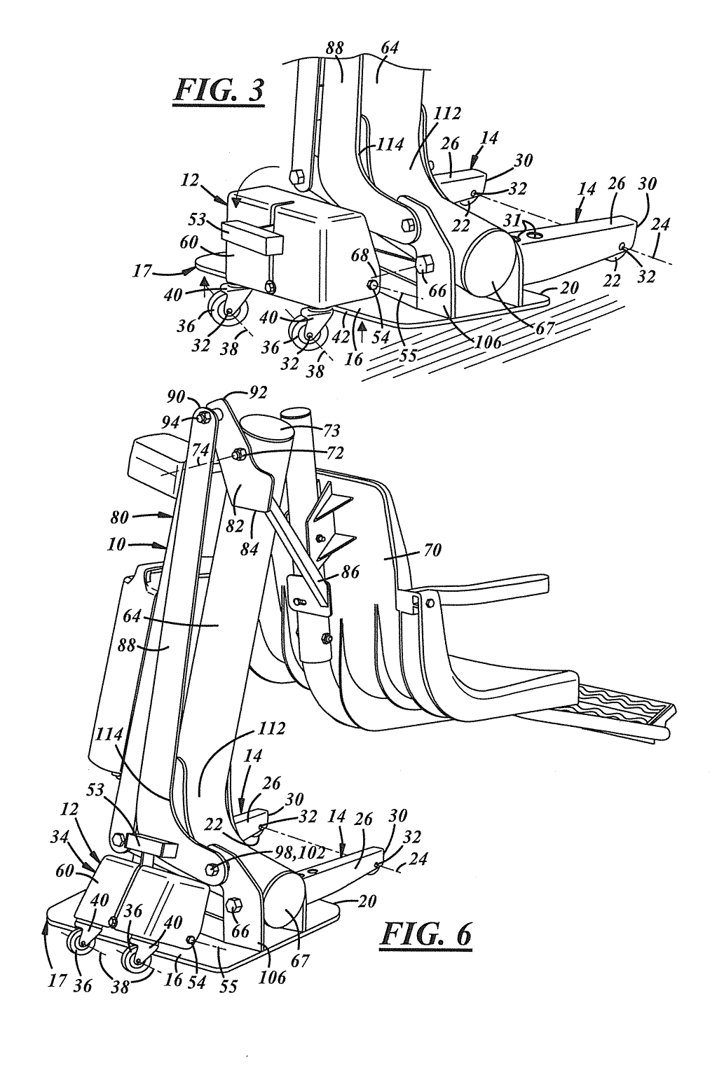

As best shown in FIGS. 2-5, the jack 34 may be actuable to lift and lower the portability apparatus 12 by alternately moving the jack wheels 36 down to respective extended positions (FIGS. 3 and 4) and up to respective retracted positions (FIGS. 2 and 5). Actuation of the jack 34 thus rotates the portability apparatus base plate 16 about the forewheel axis 24 such that the portability apparatus base plate 16 is in contact with—and may be laying flat on—a generally flat supporting surface 44 such as a pool deck when the jack wheels 36 are in their retracted positions, and such that, when the jack wheels 36 are in their extended positions, the portability apparatus base plate 16 is supported by the forewheels 22 and jack wheels 36 in a transport position spaced from the supporting surface 44.

As best shown in FIGS. 4 and 5, the jack 34 may include a jack attachment member 46 comprising a metal plate that may be rigidly and removably bolted to a pool lift base plate 16. The jack may also include an over-center linkage 48 comprising metal links 50, 51 that may be pivotally connected to one another between the jack wheels 36 and the jack attachment member 46. The over-center linkage 48 may be employed to allow an operator, with a single motion, to actuate the jack 34 to both move the jack wheels 36 to their extended position and lock the jack wheels 36 in that extended position. The over-center linkage 48 may also be employed to allow an operator, with a single motion, to unlock and move the jack wheels 36 from their extended position to their retracted position.

As best shown in FIGS. 4 and 5, the jack 34 may include an actuation T handle 53 connected to the over-center linkage 48 in a location that allows an operator to actuate the jack 34 to move the jack wheels 36 between their respective extended and retracted positions by moving the T handle 53 between respective depressed and raised positions. The jack 34 may also include a generally U-shaped tubular steel jack wheel support member 52 supported by a pair of coaxially disposed bolts 54 on the jack attachment member 46 for pivotal motion about a generally horizontal jack wheel support member axis 55 as best shown in FIG. 2. The jack wheels 36 carry the respective jack wheel forks 40 that rotatably support the jack wheels 36. The jack wheels 36 may be castered, i.e., supported for pivotal motion about generally vertical caster axes 58, by pivotable attachment of the jack wheel forks 40 to the jack wheel support member 52. The jack wheel support member 52 and the jack attachment member 46 may be interconnected by the over-center linkage 48 at respective locations spaced from the jack wheel support member axis 55 in such a way as to allow an operator to move the jack wheels 36 between their extended and retracted positions by causing the over-center linkage 48 to pivot the jack wheel support member 52 between respective open and closed positions relative to the jack attachment member 46.

The jack 34 may also include a cover shell 60 supported on the jack wheel support member 52 and the jack attachment member 46 for pivotal motion about the jack wheel support member axis 55. The cover shell 60 may comprise any suitable material and may be configured to pivot between an open position (allowing access to jack components such as the over-center linkage 48), and a closed position (protecting operators and users from internal moving parts of the jack 34).

As best shown in FIGS. 1 and 3, The pool lift apparatus 10 may comprise a pool lift apparatus base 17 supportable on the supporting surface 44, which may be adjacent an edge 61 of a basin 63 and generally above a surface level of fluid 65 retained in the basin 63. A main beam 64 may be supported on the base 17 at a main beam inner end 67 by a base axle 66 for pivotal motion about a base axis 68. The base axis 68 may be coaxially disposed with the base axle 66, and the base axle 66 may be carried by the base 17.

As best shown in FIG. 6, seat 70 may be supported on a seat axle 72 which may be carried at an outer end 73 of the main beam 64 for pivotal motion about a seat axis 74 oriented coaxially with the seat axle 72 and) generally parallel to the base axis 68. The seat 70 may be configured to carry a passenger.

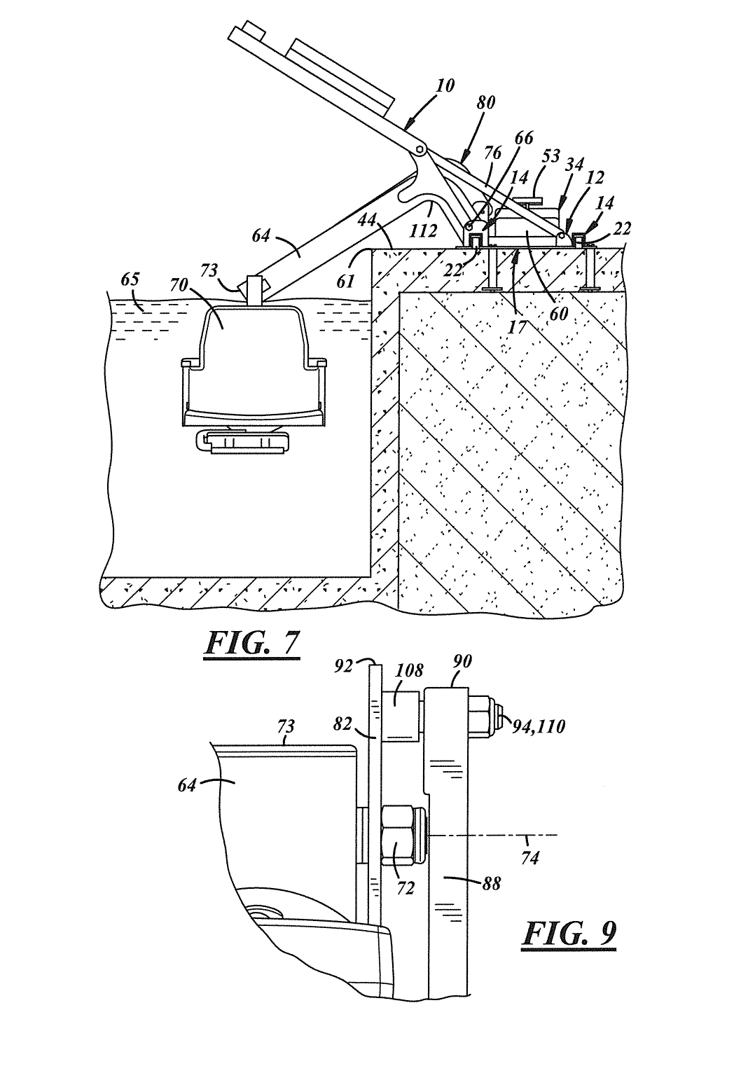

A driver 76, which may comprise a linear actuator, may be connected between the main beam 64 and a fixed structure such as the pool lift base 17 adjacent the basin 63 as best shown in FIG. 7. The driver 76 may be actuated to pivot the main beam 64 about the base axis 68 between a deployed position suspending the seat 70 at least partially within the basin 63, and a stowed position suspending the seat 70 in a position displaced laterally from the basin 63.

As best shown in FIGS. 6 and 8-10, the lift apparatus 10 may include a seat attitude maintenance linkage 80 comprising a single-side two-link crank linkage. This linkage 80 may include a short link 82 supported on the seat axle 72 for pivotal motion about the seat axis 74. As shown in FIG. 6, the short link 82 may be rigidly connected to the seat 70 at a lower end 84 of the short link 82 by a rigid brace bar 86.

The linkage 80 may also include a hockey stick-shaped long link 88 that is pivotally connected adjacent a long link outer end 90 to a short link upper end 92 at an outer pivot point 94 shared with the short link 82. The long link 88 may be pivotally connected adjacent a long link inner end 96 to the base 17 at an inner pivot point 98. The inner pivot point 98 may be defined by an inner pivot point axle in the form of a bolt 102 that passes through a hole formed in the long link 88 adjacent the long link inner end 96 and through a hole formed in an upstanding bracket 106 which may be included in the base 17. The outer pivot point 94 may be spaced from the seat axis 74 in a direction generally parallel to a direction the inner pivot point 98 is spaced from the base axis 68, and by a distance generally equal to that between the inner pivot point 98 and the base axis 68.

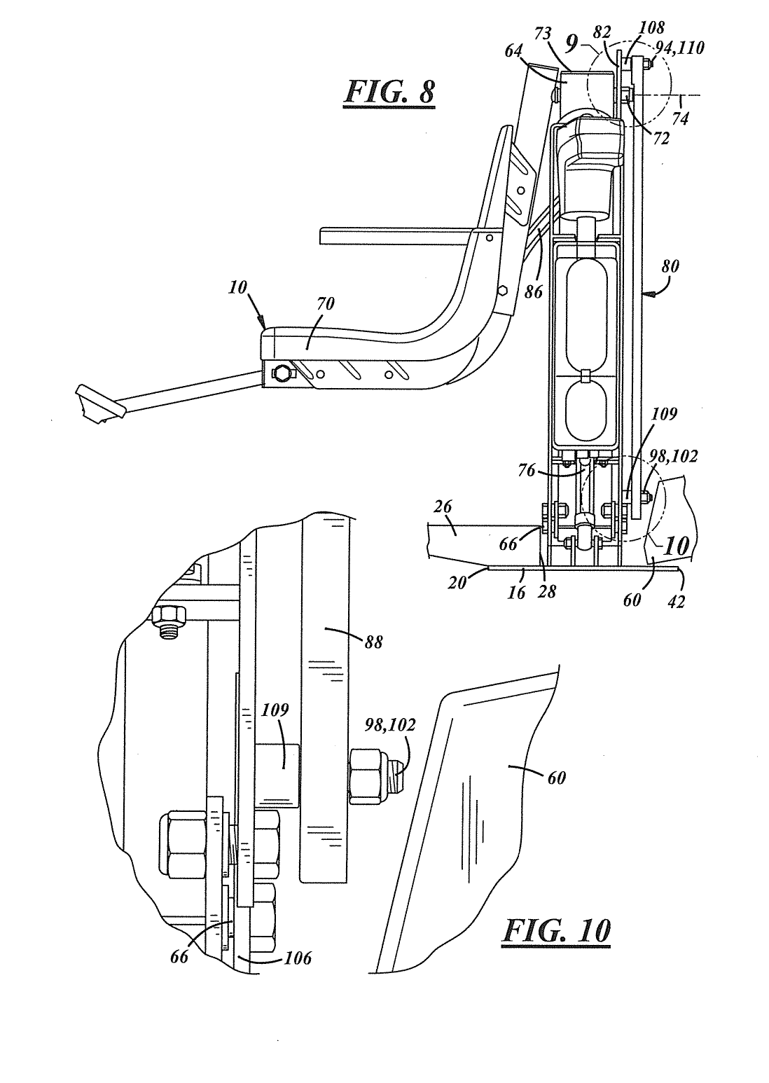

The long link 88 may be spaced from the main beam 64 by a distance sufficient to eliminate shearing action between the long link 88 and the main beam 64 as the driver 76 and linkage 80 move the main beam 64 between its deployed and stowed positions to eliminate any danger of damage to items, such as human fingers, that might be disposed between the long link 88 and the main beam 64. The space between the long link 88 and the main beam 64 may be a distance of at least 0.75 inches, and in the present embodiment, 1.350 inches, at a point along the outer end of the long link 88 where the long link 88 lies closest to the main beam 64. As shown in FIGS. 8-10, the long link 88 may be spaced from the main beam 64 by annular spacers 108, 109 carried by bolt 110 connecting the upper end of the long link 88 to the short link 82 and bolt 102 connecting the lower end of the long link 88 and the base bracket 106. Both the long link 88 and short link 82 may be disposed on a side of the main beam/support arm 64 opposite the seat 70.

As best shown in FIGS. 3 and 6, the main beam 64 of the lift apparatus 10 may include a bend 112 configured and positioned to increase the circumferential distance that the main beam 64 can be rotated around the base axis 68 without main beam travel being arrested by the edge 61 of the basin 63 into which the seat 70 is being lowered. The long link 88 may include a bend 114 positioned adjacent the bend in the main beam 64 and configured to approximate the shape of the main beam 64 such that the long link 88 may interact with the main beam 64 and other elements of the crank linkage 80 to rotate the main beam 64 around the base axis 68 without the motion of the long link 88 being arrested by the edge 61 of the basin 63 when the main beam 64 is moved to its deployed position. In other words, the long link 88 may be supported in an orientation such that its hockey stick shape generally parallels that of the main beam 64, and such that the long link 88 moves through a reciprocal scissoring motion relative to the main beam 64 as the linkage 80 moves the main beam 64 between its deployed and stowed positions.

In practice; an operator can easily prepare a pool lift apparatus 10 to be rolled from one location to another across a pool deck (or other supporting surface) by actuating the jack to move the jack wheels to their extended positions, which raises the base plate 16 of the pool lift apparatus 10 off the support surface and onto the wheels of the portability apparatus 12. Conversely, an operator can easily lower the pool lift apparatus 10 into a desired position on a supporting surface by actuating the jack to move the jack wheels to their retracted positions.

A pool lift portability apparatus constructed as described above allows an operator to mobilize a pool lift, easily move the lift to a desired location, then safely and precisely lower the lift to be secured in a desired position at the desired location.

This description, rather than describing limitations of an invention, only illustrates an embodiment of the invention recited in the claims. The language of this description is therefore exclusively descriptive and is non-limiting. Obviously, it's possible to modify this invention from what the description teaches. Within the scope of the claims, one may practice the invention other than as described above.

What is claimed is:

1. A pool lift portability apparatus comprising:
a first forewheel assembly configured to be attached to a pool lift base adjacent a forward edge of the pool lift base and comprising a first forewheel supported for rotation about a first forewheel axis; and
a jack comprising a first jack wheel supported for rotation about a first jack wheel axis, the jack being configured for attachment to the lift base in a position where the first jack wheel is spaced from the first forewheel, the jack being actuable to alternately lift and lower the pool lift by alternately moving the first jack wheel between extended and retracted positions so as to rotate the pool lift base about the first forewheel axis, the pool lift base being in contact with a supporting surface when the first jack wheel is in its retracted position, and with the pool lift base being supported by the first forewheel and the first jack wheel in a transport position spaced from the supporting surface when the first jack wheel is in its extended position.

2. A pool lift portability apparatus as defined in claim 1 in which the jack includes:
a jack attachment member configured to be attached to a pool lift base; and
an over-center linkage connected between the first jack wheel and the jack attachment member.

3. A pool lift portability apparatus as defined in claim 2 in which the jack includes an actuation handle connected to the over-center linkage in a location that allows an operator to actuate the jack to move the first jack wheel between its extended and retracted positions by moving the actuation handle between respective depressed and raised positions.

4. A pool lift portability apparatus as defined in claim 2 in which:
the jack includes a jack wheel support member supported on the jack attachment member for pivotal motion about jack wheel support member axis and carrying the first jack wheel;
the jack wheel support member and the jack attachment member are interconnected by the over-center linkage at respective locations spaced from the jack wheel support member axis in such a way as to allow an operator to move the first jack wheel between its extended and retracted positions by causing the over-center linkage to pivot the jack wheel support member between respective open and closed positions relative to the jack attachment member.

5. A pool lift portability apparatus as defined in claim 4 in which:
the jack includes a cover shell supported on the jack wheel support member and the jack attachment member for pivotal motion about the jack wheel support member axis; and
the cover shell is configured to pivot between an open position allowing access to jack components and a closed position protecting operators and users from internal moving parts of the jack.

6. A pool lift portability apparatus as defined in claim 1 in which the first jack wheel is castered

7. A pool lift portability apparatus as defined in claim 1 in which the jack includes a second jack wheel supported for rotation about a generally horizontal second jack wheel axis and spaced from the first jack wheel.

8. A pool lift portability apparatus as defined in claim 7 in which the first and second jack wheels are castered.

9. A pool lift portability apparatus as defined in claim 1 in which:
the first forewheel assembly includes a first forearm having a first forearm aft end configured for attachment to the pool lift base;
the first forearm extends forward from its aft end and beyond a forward edge of the pool lift base to a first forearm forward end; and
the first forewheel is supported on the first forearm for rotation about the first forewheel axis adjacent the first forearm outer end.

10. A pool lift portability apparatus as defined in claim 9 further including a second forewheel assembly configured to be attached to the pool lift base and comprising a second forewheel supported for rotation about a second forewheel axis.

11. A pool lift portability apparatus as defined in claim 10 in which:
the second forewheel assembly includes a second forearm having a second forearm aft end configured for attachment to the pool lift base in a position spaced from the first forearm;
the second forearm extends forward from its aft end and beyond the forward edge of the pool lift base to a second forearm forward end;
the second forearm forward end is spaced laterally from the first forearm outer end; and
the second forewheel is supported on the second forearm for rotation about the second forewheel axis adjacent the second forearm outer end.

12. A pool lift apparatus comprising:
a pool lift base supportable on a surface adjacent an edge of a basin and generally above a surface level of fluid retained in the basin;
a main beam supported on the base at a main beam inner end for pivotal motion about a base axis;
a seat supported on the main beam adjacent an outer end of the main beam for pivotal motion about a seat axis oriented generally parallel to the base axis, the seat being configured to carry a passenger;
a driver connected between the main beam and a fixed structure adjacent the basin and actuable to pivot the main beam about the base axis between a deployed position suspending the seat at least partially within the basin, and a stowed position suspending the seat in a position displaced laterally from the basin; and
a seat attitude maintenance linkage comprising a single-side two-link crank linkage including:
a short link supported for pivotal motion about the seat axis and connected to the seat,
a long link that is pivotally connected adjacent a long link outer end to a short link upper end at an outer pivot point shared with the short link, and that is pivotally connected adjacent a long link inner end to the base at an inner pivot point, the outer pivot point being spaced from the chair pivot point in a direction generally parallel to a direction the inner pivot point is spaced from the base axis, the long link being spaced from the main beam by a distance sufficient to eliminate shearing action between the long link and the main beam as the driver and linkage move the main beam between its deployed and stowed positions.

13. A pool lift apparatus as defined in claim 12 in which the long link is spaced from the main beam by a distance of at least 0.075 inch.

14. A pool lift apparatus as defined in claim 12 in which:
the main beam includes a bend configured and positioned to increase the circumferential distance that the main beam can be rotated around the base axis without main beam travel being arrested by the edge of a basin into which the seat is being lowered; and
the long link includes a bend positioned adjacent the bend in the main beam and configured to allow the long link to interact with the main beam and other elements of the crank linkage to rotate the main beam around the base axis without the motion of the long link being arrested by the edge of the basin when the main beam is moved to its deployed position.

15. A pool lift apparatus as defined in claim 12 in which the long link and short link are disposed on a side of main beam/support arm opposite the chair.

16. A portable pool lift apparatus comprising:
a pool lift base supportable on a surface adjacent an edge of a basin and generally above a surface level of fluid retained in the basin;
a main beam supported on the base at a main beam inner end for pivotal motion about a base axis;
a seat supported on the main beam adjacent an outer end of the main beam for pivotal motion about a seat axis oriented generally parallel to the base axis, the seat being configured to carry a passenger;
a driver connected between the main beam and a fixed structure adjacent the basin and actuable to pivot the main beam about the base axis between a deployed position suspending the seat at least partially within the basin, and a stowed position suspending the seat in a position displaced laterally from the basin;
a first forewheel assembly attached to the pool lift base adjacent a forward edge of the pool lift base and comprising a first forewheel supported for rotation about a first forewheel axis; and
a jack attached the pool lift base and comprising a first jack wheel supported for rotation about a first jack wheel axis, the jack being configured for attachment to the pool lift base in a position where the first jack wheel is spaced from the first forewheel, the jack being actuable to alternately lift and lower the pool lift by alternately moving the first jack wheel between extended and retracted positions so as to rotate the pool lift base about the first forewheel axis, the pool lift base being in contact with a supporting surface when the first jack wheel is in its retracted position, and with the pool lift base being supported by the first forewheel and the first jack wheel in a transport position spaced from the supporting surface when the first jack wheel is in its extended position.

17. A portable pool lift apparatus as defined in claim 16 in which the jack includes:
a jack attachment member configured to be attached to a pool lift base; and
an over-center linkage connected between the first jack wheel and the jack attachment member.

18. A portable pool lift apparatus as defined in claim 17 in which the jack includes an actuation handle connected to the over-center linkage in a location that allows an operator to actuate the jack to move the first jack wheel between its extended and retracted positions by moving the actuation handle between respective depressed and raised positions.

19. A portable pool lift apparatus as defined in claim 17 in which:
the jack includes a jack wheel support member supported on the jack attachment member for pivotal motion about jack wheel support member axis and carrying the first jack wheel;
the jack wheel support member and the jack attachment member are interconnected by the over-center linkage at respective locations spaced from the jack wheel support member axis in such a way as to allow an operator to move the first jack wheel between its extended and retracted positions by causing the over-center linkage to pivot the jack wheel support member between respective open and closed positions relative to the jack attachment member.

20. A portable pool lift apparatus as defined in claim 19 in which:
the jack includes a cover shell supported on the jack wheel support member and the jack attachment member for pivotal motion about the jack wheel support member axis; and
the cover shell is configured to pivot between an open position allowing access to jack components and a closed position protecting operators and users from internal moving parts of the jack.

21. A portable pool lift apparatus as defined in claim 17 in which the first jack wheel is castered

22. A portable pool lift apparatus as defined in claim 17 in which the jack includes a second jack wheel supported for rotation about a generally horizontal second jack wheel axis and spaced from the first jack wheel.

23. A portable pool lift apparatus as defined in claim 22 in which the first and second jack wheels are castered.

24. A portable pool lift apparatus as defined in claim 17 in which:
the first forewheel assembly includes a first forearm having a first forearm aft end configured for attachment to the pool lift base;
the first forearm extends forward from its aft end and beyond a forward edge of the pool lift base to a first forearm forward end; and
the first forewheel is supported on the first forearm for rotation about the first forewheel axis adjacent the first forearm outer end.

25. A portable pool lift apparatus as defined in claim 24 further including a second forewheel assembly configured to be attached to the pool lift base and comprising a second forewheel supported for rotation about a second forewheel axis.

26. A portable pool lift apparatus as defined in claim 25 in which:
the second forewheel assembly includes a second forearm having a second forearm aft end configured for attachment to the pool lift base in a position spaced from the first forearm;
the second forearm extends forward from its aft end and beyond the forward edge of the pool lift base to a second forearm forward end;
the second forearm forward end is spaced laterally from the first forearm outer end; and
the second forewheel is supported on the second forearm for rotation about the second forewheel axis adjacent the second forearm outer end.

27. A portable pool lift apparatus as defined in claim 16 further comprising a seat attitude maintenance linkage comprising a single-side two-link crank linkage including:
a short link supported for pivotal motion about the seat axis and connected to the seat, and
a long link that is pivotally connected adjacent a long link outer end to a short link upper end at an outer pivot point shared with the short link, and that is pivotally connected adjacent a long link inner end to the base at an inner pivot point, the outer pivot point being spaced from the chair pivot point in a direction generally parallel to a direction the inner pivot point is spaced from the base axis, the long link being spaced from the main beam by a distance sufficient to eliminate shearing action between the long link and the main beam as the driver and linkage move the main beam between its deployed and stowed positions

28. A pool lift apparatus as defined in claim 27 in which the long link is spaced from the main beam by a distance of at least 0.075 inch.

29. A pool lift apparatus as defined in claim 27 in which:
the main beam includes a bend configured and positioned to increase the circumferential distance that the main beam can be rotated around the base axis without main beam travel being arrested by the edge of a basin into which the seat is being lowered; and
the long link includes a bend positioned adjacent the bend in the main beam and configured to allow the long link to interact with the main beam and other elements of the crank linkage to rotate the main beam around the base axis without the motion of the long link being arrested by the edge of the basin when the main beam is moved to its deployed position.

30. A pool lift apparatus as defined in claim 27 in which the long link and short link are disposed on a side of main beam/support arm opposite the chair
